(19) United States
(12) Patent Application Publication
(10) Pub. No.: US 2005/0044351 A1
(43) Pub. Date: Feb. 24, 2005

(54) Digital time stamping system

(76) Inventor: Ian Nigel Harvey, Cambridge (GB)

Correspondence Address: MORGAN & FINNEGAN, L.L.P., 3 WORLD FINANCIAL CENTER, NEW YORK, NY, 10281-2101, US

(21) Appl. No.: 10/487,897

(22) PCT Filed: Jul. 23, 2002
(86) PCT No.: PCT/GB02/03357

(30) Foreign Application Priority Data
Sep. 13, 2001 (GB) 0122169.6

(51) Int. Cl. H04L 9/00

(52) U.S. Cl. 713/153

(57) ABSTRACT

A digital time-stamping system for issuing stamps on messages by means of a cryptographic digital signature includes a front end unit (10), a load balancer (50) and one or more public key signature units (60). Incoming messages are rapidly and temporarily time-stamped by means of a MAC generator (30) in the front end unit, and the message is then passed on to the load balancer. The load balancer queues the messages, and passes them on at an appropriate speed to the public key signature units (60), which verifies the MAC and resigns the message with a public key signature. The front end unit (10) and the public key signature units (60) are preferably individual secure modules with the load balancer (50) being outside the security boundaries. The system enables large numbers of incoming messages to be accurately time-stamped in a secure manner.

The present invention relates to digital time stamping systems.

Digital time stamping systems are typically used for applying time stamps on messages or documents by means of a cryptographic digital signature. A typical implementation uses a local time source to determine the time along with hardware which implements a digital signature algorithm and which stores a key for that algorithm.

In general, the digital signatures used for time stamps are created using a public key algorithm. This has the property that the key (the public key) used to check the signature is not the same as the key (the private key) used to produce it. This means that anyone can check that the time-stamp is correct, but only the holder of the private key can issue the time stamps.

Unfortunately, public-key algorithms are mathematically complex and take a lot of time to compute. This means that any one time-stamp issuing device can only issue a small number of time-stamps per second. Obviously, in many situations a time-stamp must be issued swiftly and a processing delay could render the stamp useless.

A conventional approach to this situation is to employ multiple time-stamping devices, so that many requests for time-stamps can be split amongst the different devices. However, this immediately creates another problem: one major use of timestamps is to establish the sequence of events (did the seller change his stock price before or after the buyer committed to buy?): If the time-stamps on these events are generated by different devices, the sequence can only be guaranteed if their clocks are exactly in synchronisation. Synchronising clocks is, in general, a different activity, and as more timestamps per second are required:
(a) the number of devices needing synchronisation goes up, and;
(b) they must all be synchronised to a greater accuracy (i.e. less than the smallest gap between events which need sequencing).

It is one object of the present invention at least to alleviate these difficulties. It is a further object to provide a high speed, but secure, digital time-stamping system.

According to the present invention there is provided a digital time-stamping system comprising:
(a) a first signature generator for receiving an incoming message, combining the message with time of arrival information, and digitally signing it to create a temporary signed message;
(b) a signature verifier for verifying the signature of the temporary signed message; and
(c) a second signature generator for creating, where authorised to do so by the signature verifier, an output time-stamped message by digitally signing a combination of the message and the time of arrival information.

Preferably, the first signature generator uses a cryptographic Message Authentication Code (MAC). This a type of signature where the signer of the message, and the verifier of the message, both use the same key. Although MACs do not have the desirable property that anyone can verify the signature, they are several orders of magnitude faster to compute than a public key signature algorithm. In the preferred embodiment, a fast MAC is used to bind a time stamp to a message, and which is later on converted to a public key signature.

Preferably, the system may include a first secure area, for example a hardware module, containing the first signature generator, and/or a second secure area (for example a hardware module) containing the signature verifier. The second module may also include the public key signature generator. Secure key stores may be provided in both areas/modules, the first for storing the key needed to generate the temporary signed message, and the second the key needed to verify it. Preferably, those keys are the same, as for example where a MAC is used to create the temporary signed message. Where provided, the second key store may also contain the key or keys needed by the second signature generator, and to that end the second signature generator is also preferably contained within the second secure area.

The second key may comprise the private part of a public/private key pair, as used by any convenient public key cryptosystem such as RSA.

A plurality of second secure areas or modules may be provided, with a load balancer being used to spread the load between the modules. The load balancer may, but need not, be contained within the cryptographically secure boundaries of the first and/or second secure areas.

According to a second aspect of the present invention there is provided a method of digital time-stamping comprising:
(a) receiving an incoming message, combining the message with time of arrival information and digitally signing it to create a temporary signed message;
(b) verifying the signature of the temporary signed message; and
(c) where the verification is successful, creating an output time-stamped message by digitally signing a combination of the message and the time of arrival information.

The invention further extends to a computer program for implementing the above method, and to a computer-readable media on which such a computer program is stored.

The invention may be carried into practice in a number of ways and one specific embodiment will now be described, by way of example, with reference to the accompanying drawings, in which:

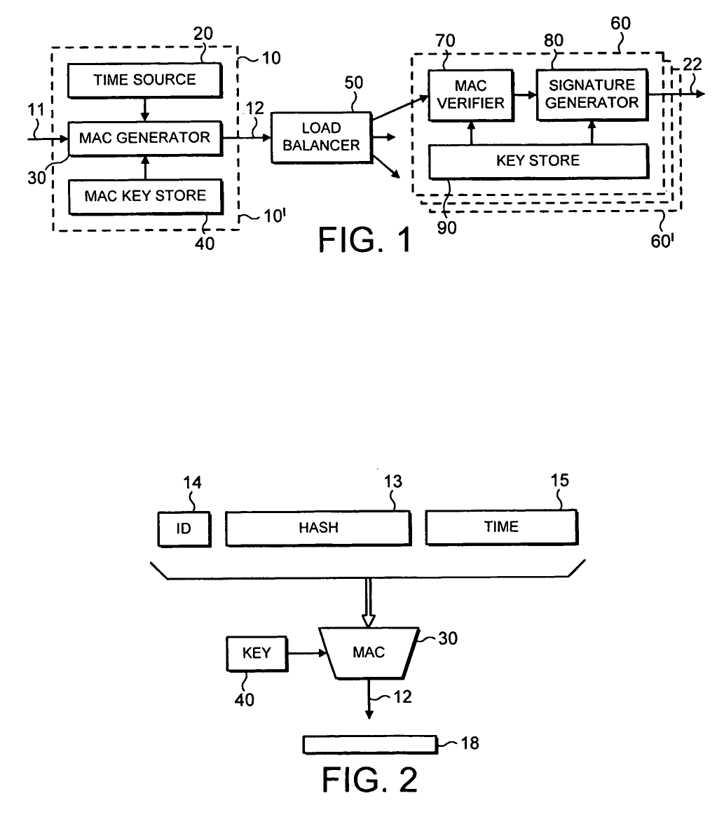

FIG. 1 is a block diagram of the preferred embodiment; and

FIG. 2 illustrates the operation of MAC generator.

The system of the preferred embodiment, as illustrated schematically in FIG. 1, consists of a front end unit 10, a load balancer 50, and one or more public key signature units 60. The front end rapidly signs incoming messages with a temporary time stamped signature, and these are then passed on by the load balancer to the public key signature units which verify the temporary signatures and resign the original messages with a public key.

The front end unit 10 contains a time source 20, a MAC generator 30 and a MAC key store 40. Incoming messages to be time-stamped arrive at an input 11, are stamped by the MAC generator 30, and are then passed via an output 12 to the load balancer 50. The MAC generator can use any convenient standard MAC (Message Authentication Code), including HMAC (Hash MAC) or CBC MAC (Block-cipher MAC).

The operation of the MAC generator 30 is shown in more detail in FIG. 2. The incoming message to be time-stamped will typically include a hash 13 of a document, along with a unique header or ID 14. If no header is provided, that may be generated automatically by the front end unit 10. It will be understood, of course, that the principle of operation of the system does not depend upon the type of message to be signed: in appropriate circumstances, the hash 13 could be replaced with some other data uniquely indicative of the document to be signed, or could indeed be an electronic copy of the document in its entirety.

The ID 14, the hash 13 and a time 15 generated by the time source 20 are concatenated as indicated by the reference numeral 16, and are fed into the MAC generator 30. This uses the appropriate key from the key store 40 to generate a temporary time-stamped message 18 at the output 12.

Because MACs can be generated extremely rapidly, incoming messages can be dealt with promptly and passed on without delay to the load balancer. At the load balancer, the temporary time-stamped messages 18 may be queued if necessary and passed on to the public key signature units 60 at a rate they can handle. If the final time-stamps are not required particularly quickly, so that a single signature unit could eventually “catch up” on the workload, the load balancer 50 may simply make use of a single queue. Alternatively, several signature units 60 may be used, with the load balancer sharing out the workload between them.

The signature units 60 are responsible for converting the temporary time-stamped messages 18 into public key time-stamped messages which can then be output on one or more outputs 22. Conveniently, messages appearing on the output or outputs 22 will then be sent to a central store (not shown) from where they can be publicly accessed in the normal way.

Each signature unit 60 contains a secure key store 90, a MAC verifier 70 and a signature generator 80.

When a temporary time-stamped message arrives it is passed to the MAC verifier 70 which checks the MAC using a copy of the original MAC key, stored in the key store 90. If this verification fails, it is assumed that the message has been tampered with, and the request is discarded. Otherwise, the time of arrival at the front end unit, as indicated by the time string 15, is genuine, and the ID 14, hash 13 and time 15 are passed to the signature generator 80. This applies a public key signature using an appropriate public key, retrieved from the key store 90 to generate the finished time-stamped message. Any type of public key cryptosystem could be used to generate the final signature, such as RSA.

Since the same MAC keys are used both by the front end unit and the public key signature units, it is preferred that those keys are stored in a secure manner. In the preferred embodiment, the front end unit 10 and each of the public key signature units 60 comprise secure hardware modules, the security perimeters of which are illustrated by the dotted lines in FIG. 1. The secure area for the front end unit is illustrated by the dotted lines 10′, and the secure area for the public key signature units are illustrated by the dotted lines 60′. The keys stored within these units cannot be extracted, deleted or modified in any way without the user presenting appropriate security credentials.

In such an arrangement, the load balancer 50 is outside the security boundaries: that does not pose a security threat since all of the messages which pass outside the secure area are MAC protected, and cannot be modified by any third party who does not have access to the securely-stored MAC keys.

The front end unit, the load balancer and the public key signature units may but need not be located physically within the same computer. Since the MAC encoded messages do not need to be kept within a secure environment, the front end unit, the load balancer and the public key signature units could be widely separated physically, and could even be in different continents. Message passing between the front end unit and the load balancer, and between the load balancer and the public key signature units, could be via any convenient communications medium including a wired or wireless network, or the internet.

Alternatively, in a variant of the embodiment, all of the elements shown in FIG. 1 could be contained within a single secure hardware module, having just a single input 11 and a single output 22.

1. A digital time-stamping system comprising:
(a) a first signature generator for receiving an incoming message, combining the message with time of arrival information, and digitally signing it to create a temporary signed message;
(b) a signature verifier for verifying the signature of the temporary signed message; and
(c) a second signature generator for creating, where authorised to do so by the signature verifier, an output time-stamped message by digitally signing a combination of the message and the time of arrival information.

2. A digital time-stamping system as claimed in claim 1 in which the first signature generator digitally signs using a cryptographic Message Authentication Code.

3. A digital time-stamping system as claimed in claim 1 in which the second signature generator digitally signs using a cryptographic public key system.

4. A digital time-stamping system as claimed in claim 1 including a load balancer for receiving and holding the temporary signed message and for passing it on to the signature verifier.

5. A digital time-stamping system as claimed in claim 4 in which the load balancer includes a temporary message queue.

6. A digital time-stamping system as claimed in claim 4 including a plurality of signature verifiers and corresponding second signature generators, the load balancer controlling message transmission to the respective signature verifiers.

7. A digital time-stamping system as claimed in claim 1 in which the first signature generator uses a first key to create the temporary signed message and the signature verifier uses a copy of the first key to verify the signature.

8. A digital time-stamping system as claimed in claim 7 in which the first key and the copy of the first key are both securely stored.

9. A digital time-stamping system as claimed in claim 1 in which the first signature generator is contained within a first secure area.

10. A digital time-stamping system as claimed in claim 9 in which the first secure area is a secure first hardware module.

11. A digital time-stamping system as claimed in claim 10 in which the first secure area contains a first key store which holds a first key used by the first signature generator to create the temporary signed message.

12. A digital time-stamping system as claimed in claim 11 in which the first secure area includes a time source for generating time of arrival information.

13. A digital time-stamping system as claimed in claim 10 in which the signature verifier is contained within a second secure area.

14. A digital time-stamping system as claimed in claim 13 in which the second secure area is a second secure hardware module.

15. A digital time-stamping system as claimed in claim 14 in which the second secure area includes a second key storage which holds a copy of the first key for use by the signature verifier to verify the signature of the temporary signed message.

16. A digital time-stamping system as claimed in claim 13 in which the second signature generator is contained within the second secure area.

17. A digital time-stamping system as claimed in claim 16 in which the second secure area includes a second key store which holds a second key for use by the second signature generator to create the output time stamped message.

18. A digital time-stamping system as claimed in claim 1 including a first secure area containing the first signature generator and a second secure area containing the signature verifier.

19. A digital time-stamping system as claimed in claim 18 in which the first and second secure areas comprise respective first and second secure hardware modules.

20. A digital time-stamping system as claimed in claim 18 in which the first signature generator uses a first key stored within the first secure area and the signature verifier uses a copy of the first key stored in the second secure area.

21. A digital time-stamping system as claimed in claim 18 including a load balancer for receiving and holding the temporary signed message and for passing it on to the second secure area, the load balancer being outside both the first and second secure areas.

22. A digital time-stamping system as claimed in claim 21 including a plurality of second secure areas each containing a respective signature verifier, the load balancer controlling message transmission to the second secure areas.

23. A digital time-stamping system as claimed in claim 18 in which the temporary signed message passes out of the first secure area on its way to the second secure area.

24. A digital time-stamping system as claimed in claim 1 including a time source for generating the time of arrival information.

25. A method of digital time-stamping comprising:
(a) receiving an incoming message, combining the message with time of arrival information, and digitally signing it to create a temporary signed message;
(b) verifying the signature of the temporary signed message; and
(c) where the verification is successful, creating an output time-stamped message by digitally signing a combination of the message and the time of arrival information.

26. A computer program for carrying out the method as claimed in claim 25.

27. A computer-readable media carrying the computer program as claimed in claim 26.
